(19) United States
(12) Patent Application Publication
(10) Pub. No.: US 2007/0276942 A1
(43) Pub. Date: Nov. 29, 2007

(54) Method for providing a personalized user greeting

(75) Inventor: Gaurav Wadhwa, Haryana (IN)

Correspondence Address: KENYON & KENYON LLP, RIVERPARK TOWERS, SUITE 600, 333 W. SAN CARLOS ST., SAN JOSE, CA, 95110, US

(73) Assignee: SAP AG, Walldorf (DE)

(21) Appl. No.: 11/429,611

(22) Filed: May 5, 2006

(51) Int. Cl. G06F 15/173

(52) U.S. Cl. 709/225

(57) ABSTRACT

A method for providing information to a user of an electrical device as a part of a user greeting. The user selects personalized information he wants to include in the user greeting. A user greeting program is initiated by signals from a user interface and determines the type of personalized information selected by the user. The user greeting program accesses at least one information source within a corporate computer system to obtain the personalized information, and then presents the obtained information as a part of the user greeting. The information source could be a database storing information of employees of a corporation, a groupware application storing the user's schedule, or the user's task list. The user greeting could further include publicly available information.

### BACKGROUND

Nowadays, computers and other electrical devices play a more and more important role in people's lives and work. In addition to being used as a tool for word and data processing, a computer can be used to keep a user's contacts, schedule and task list. The computer is also replacing newspapers, radio and TV and becoming an important tool for information access. With a computer, a user can get information in which he is interested, for example, his schedule, announcements of his company, news, weather forecast, stock market information, etc.

However, to get the information in which he is interested, the user has to open different application programs in the computer, or to go to different webpages of an Intranet of his company or the Internet, after logging in the computer. This is time-consuming and not user-friendly. When the user is very busy, he may forget to look at the information he should have checked, and make a wrong decision or miss an important event.

Thus, it would be desirable to provide a system which provides the user with information he is interested in a more convenient way.

### BRIEF DESCRIPTION OF THE DRAWINGS

FIG. 1 is a flow chart of a method for providing a personalized user greeting according to one embodiment of the present invention.

FIG. 2 shows a screen with personalized user greeting according to one embodiment of the present invention.

FIG. 3 shows a screen used to configure a user greeting according to one embodiment of the present invention.

FIG. 4 shows an exemplary system environment of a user greeting program according to one embodiment of the present invention.

FIG. 5 illustrates a flow chart of a method for providing personalized user greeting with information from groupware according to one embodiment of the present invention.

### DETAILED DESCRIPTION OF EMBODIMENTS

The present invention overcomes problems of the prior art by presenting a personalized user greeting, which includes time-sensitive information a user is specifically interested. Advantages of the present invention will become apparent from the following detailed description.

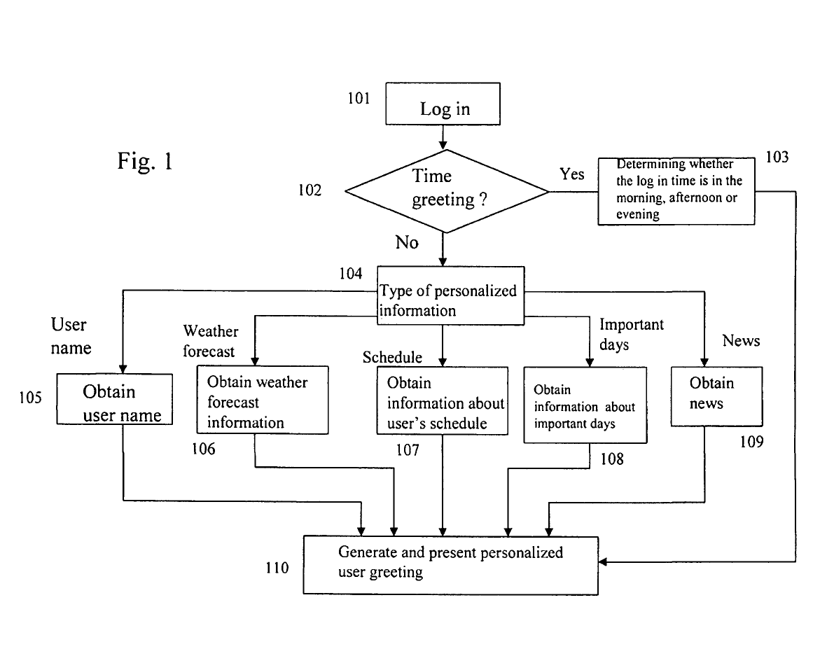

FIG. 1 is a flow chart of a method for providing a personalized user greeting according to one embodiment of the present invention. At 101, a computer system may present a log in page to a user, asking the user to provide user name and password. The computer system may also ask the user to provide additional log in information, e.g., location of the user's office. The log in page could be displayed during the initiation process of the computer after the user presses the on/off button of computer, or when the user moves the mouse or presses a key on the keyboard during the standby mode of the computer.

At 102, it may be determined whether the user has chosen a time greeting. If not, the process proceeds to 104. Otherwise, at 103, a user greeting program may compare the user's log in time and a system clock, and determines whether the user's log in time is in the morning, afternoon, or evening, so as to present the time greeting accordingly. In one embodiment, the system time is stored in a CMOS battery chip on the PC Motherboard. The user greeting program may get system time from the CMOS, and based on that time it may decide the time greeting message to be displayed.

For example, if the user's log in time is before 12 pm, “Good morning” may be presented as a part of the user greeting. If the user's log in time is between 12 pm and 5 pm, “Good afternoon” may be presented as a part of the user greeting. If the user's log in time is between 5 pm and 12 am, “Good evening” may be presented as a part of the user greeting.

Although 101-103 are shown in the embodiment of FIG. 1, they are optional. The user greeting program could also be initiated after the user has logged in, for example, when the user refreshes a page, or navigates from one page to another page. The user could define other events that could start the user greeting program. In this type of situation, if the user prefers a time greeting, the user greeting program compares the time it was initiated and the system clock.

At 104, it is decided what type of information the user wants to include in the user greeting.

If the user has chosen to show his schedule of the day as a part of the user greeting, at 105, the user greeting program interacts with an application storing schedule to obtain the user's schedule. The application could be, for example, groupware. Groupware is software that supports multiple users working on related tasks in local and remote networks. An example of groupware is Lotus Notes. Another example of groupware is the Outlook™ from Microsoft™. In one embodiment, the user greeting program obtains the user's schedule of the week from a groupware application.

If the user prefers to display important days of his family members or friends or colleagues as a part of the user greeting, at 106, the user greeting program interacts with an application on the user's computer, or a database in his company's computer system to get such information.

If the user prefers to include his task(s) of the day or the week in the user greeting, at 107, the user greeting program interacts with an application storing his task list. The application could be, for example, a groupware application.

Boxes 105, 106 and 107 show only a few examples of personalized information which could be included in the user greeting. The user could choose other personalized information to be included in the user greeting. In the present invention, personalized information means information stored in the user's computer, or information stored in the computer system of the user's company and available to internal users only. The user greeting program may obtain personalized information from, for example, groupware or a company's internal database.

The user could also choose to include publicly available information in his user greeting. For example, if the user has chosen to display weather forecast as a part of the user greeting, at 108, the user greeting program may interact with a weather forecast website to obtain the current weather forecast information.

If the user prefers to include important news in the user greeting, at 109, the user greeting program may interact with a news channel or a newspaper website to obtain the news.

Similarly, if the publicly available information preferred by the user is prices of certain stocks, or results of sport games, the user greeting program may collect such information from relevant websites and present it as a part of the user greeting.

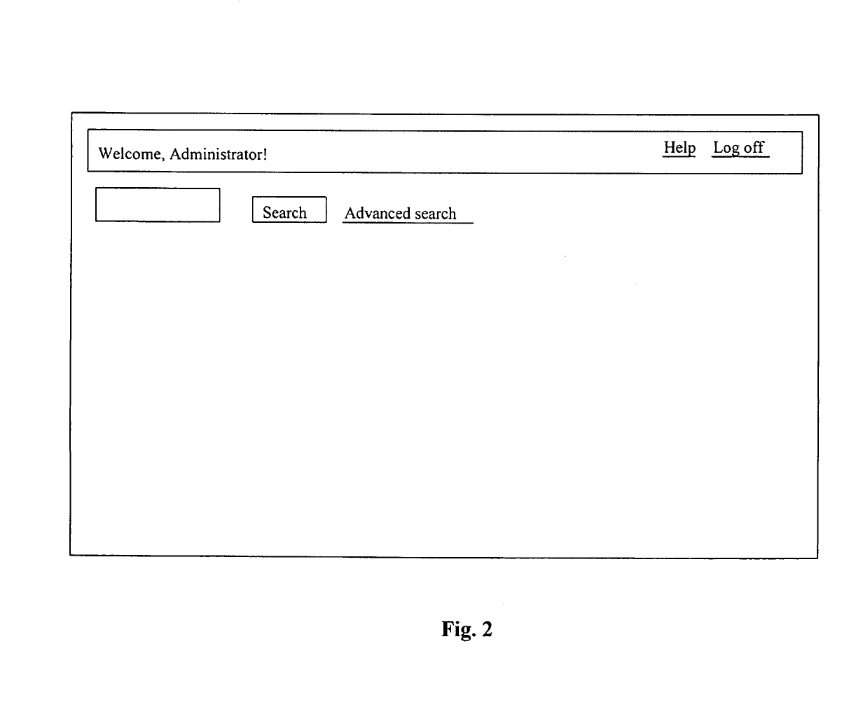

Additional, if the user prefers to include his/her name in the user greeting, at 110, the user greeting program may obtain the user's name from the log in information. The user's name could be his full name, first name or last name. A user's job title, e.g., administrator, could also be used, as shown in FIG. 2.

At 111, the user greeting program generates a user greeting according to the user's preference and the information obtained in 105-110.

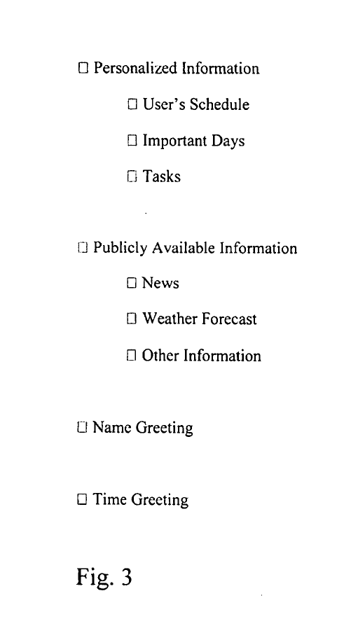

A user or an administrator could configure what is included in the user greeting. A screen shown in FIG. 3 is presented to the user via a user interface. The user selects at least one type of personalized information from the group including user's schedule, important days of family members, friends and colleagues, and task list. The user could select publicly available information, such as weather forecast and news. The user could also select name greeting and/or time greeting.

In one embodiment, the user may choose to include only his task of the day in the user greeting. An example of the user greeting is: “Market survey of Product XYZ is due today.” The information about the user's task may be obtained from a groupware application.

In another embodiment, the user may choose to include his name and schedule in the user greeting. The user greeting program may present the user greeting as: “John, you have a meeting with Philip at 10 am, and have a lunch meeting with Denis at the cafeteria.” The information about the user's schedule may be obtained from a groupware application.

In another embodiment, the user may choose to include time greeting, his name and important days in the user greeting. An example of the user greeting is: “Good Morning, John. Today is your friend Mr. Smith's Birthday.”

In one embodiment, the user greeting program interacts with the Employee/user Master Data(tables) in a company's database and groupware. Consequently, the user greeting program can get information about the user's contacts and their birthdays as well as the user's birthday and his/her important meetings for that day. An example of the user greeting is: “Welcome. Today is your friend Mr. Smith's Birthday. You have a meeting with Denis at 4 pm.”

In another embodiment, the user chooses to include time greeting and his schedule in the user greeting. An example of the user greeting is: “Good Morning. You have a meeting with Denis at 4 pm.”

If the user prefers that his schedule and the weather forecast are shown in the user greeting, the user greeting program may interact with some weather forecast websites to get the information about weather condition in the geographical region the user's PC located. The user greeting program may present the user greeting as: Welcome, You have a meeting with Denis at 4 pm. Today is sunny, 58° F. to 49° F.

If the user chooses to include time greeting, important dates and weather forecast in the user greeting, the user greeting program may present the user greeting as: “Good Morning. Happy Birthday, John. It's a sunny day.”

In one embodiment, every time the user logs in, or every time the user navigates through the system, i.e. whenever the user performs some action on the system, the user greeting program may retrieve the time, his schedule and weather details again and displays the new user greeting accordingly. For example, at 11:50 am, if the user logs in to the system, the system may greet the user as: “Good morning, John. You have a meeting with Philip at 2 pm and a meeting with Joe at 4 pm. It's a sunny day!” When the user comes back to his desk at 3 pm after his meeting with Philip, and either refreshes his page or navigates to another page, then the user greeting may be different, for example: “Good afternoon, John You have a meeting with Joe at 4 pm. It's going to rain.”

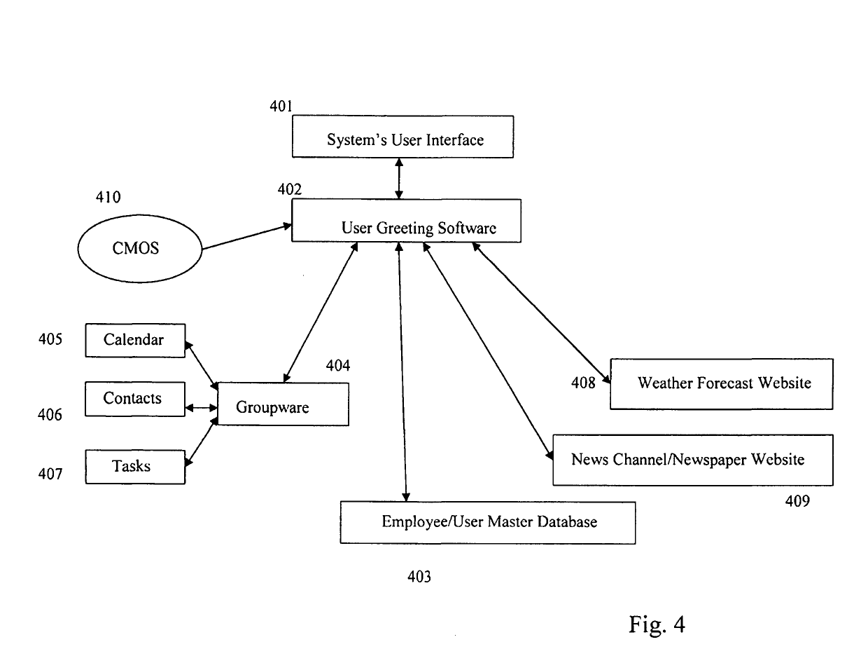

FIG. 4 shows an exemplary system environment of a user greeting program according to one embodiment of the present invention. A user interface 401 may include a monitor, user input devices such as a keyboard and a mouse, and software for processing signals from the user input devices and signals to the monitor. The user interface 401 may receive input from a user via the keyboard or the mouse. When the user changes the state of the computer, the user interface 401 may detect the user's activity and sends a signal to a user greeting program 402 to initiate the user greeting program. The user may change the state of the computer by, for example, turning on the computer, moving the mouse or pressing a key during the standby mode, or navigating from one page to another page.

The user interface 401 may collect the user's log in information, such as the user name and/or the log in time, and transmits the log in information to the user greeting program 402.

The user greeting program 402 interacts with a number of information sources to obtain information that the user wants to include in the user greeting. The information sources include sources for time sensitive personalized information, such as an employee/user master database 403, and groupware 404. The groupware may further include Calendar 405, Contacts 406 and Tasks 407.

The user greeting program 402 also could interact with sources for publicly available information, such as a weather forecast website 408, and a news channel or newspaper website 409.

Although FIG. 4 shows a number of different information sources, the present invention is not so limited. The user greeting program could interact with only one personalized information source, or any combination of at least one personalized information source and other information sources. The user greeting program could of course interact with more information sources, such as websites for stock market, and websites for sport game results. If the user prefers a time greeting, the user greeting program 402 obtains the system time from a CMOS battery chip 410.

The user sets his user greeting preference via the user interface. A screen shown in FIG. 3 is presented to the user. The user selects at least one type of personalized information, and could also select name greeting, time greeting and publicly available information.

After the user greeting program generates the user greeting according to the user's input and selection, the monitor displays the user greeting in response to signals from the user greeting program 402. The user greeting could be displayed at the top of the screen, as shown in FIG. 2, or at any other places on the screen. The user greeting could be displayed in the manner similar to balloon help. The user greeting could also be presented as audio signals.

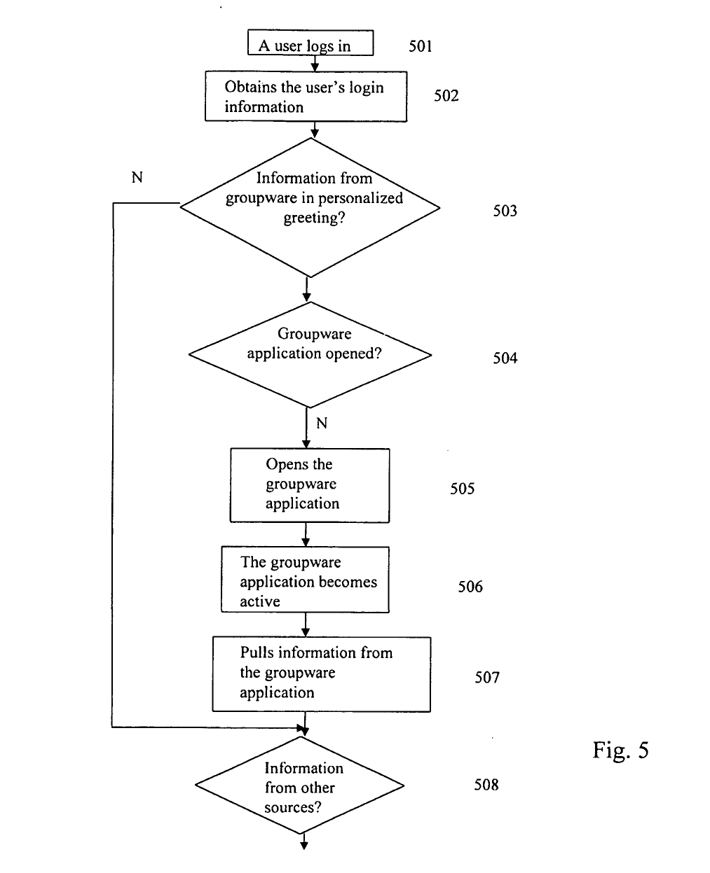

FIG. 5 illustrates a flow chart of a method for providing personalized user greeting with information from groupware according to one embodiment of the present invention.

At 501, a user logs in, providing his user name and password. At 502, the user greeting program may obtain the user's login information. At 503, the user greeting program may determine whether the user has chosen to include in his personalized greeting any information from the groupware, e.g., his calendar, his tasks, and/or his contacts. If not, the process proceeds to 508. If the user has included in his personalized greeting information from the groupware, at 504, the user greeting program may determine whether the groupware application has already been opened. If not, the groupware application may be opened at 505. The user greeting program may cause the groupware application to become active at 506 and pull the information of interest (the task, the calendar appointment, the contacts, etc.) at 507. In one embodiment, the user may prioritize the information from the groupware application. For example, the user may give the calendar appointment the highest priority. At 508, the user greeting program may determine whether the user has chosen information from other sources.

While the invention has been described in detail above with reference to some embodiments, variations within the scope and spirit of the invention will be apparent to those of ordinary skill in the art. Thus, the invention should be considered as limited only by the scope of the appended claims.

1. A method for providing information to a user of an electrical device, comprising:
obtaining the user's log in information;
determining whether a first type of time sensitive personalized information should be included in a user greeting;
accessing a groupware application to obtain the first type of personalized information; and
presenting obtained personalized information to the user as a part of the user greeting,
wherein the personalized information is available only to users of a corporate computer system.

2. The method of claim 1, wherein the first type of personalized information is the user's schedule.

3. The method of claim 1, wherein the first type of personalized information is the user's task list.

4. The method of claim 1, wherein the first type of personalized information is the user's contacts.

5. The method of claim 1, further comprising obtaining a second type of personalized information.

6. The method of claim 5, wherein the second type of personalized information is from a database storing information of users of the corporate computer system.

7. The method of claim 6, wherein the second type of personalized information is information about a second user.

8. The method of claim 1, wherein the user greeting is shown in a balloon on the screen of the electrical device.

9. The method of claim 1, further comprising obtaining publicly available information and including the publicly available information in the user greeting.

10. The method of claim 1, further comprising showing time greeting in the user greeting.

11. The method of claim 1 being initiated when the user navigates from one page to another page.

12. The method of claim 1, further comprising opening the groupware application.

13. The method of claim 1, further comprising activating the groupware application.

14. A computer program product containing program code for performing the method of claim 1.

15. A method for providing information to a user of a corporate computer system, comprising:
receiving the user's configuration of a user greeting;
obtaining the user's log in information;
determining what type of personalized information should be included in a user greeting for the user according to the log in information;
receiving a first type of time sensitive personalized information from a groupware application;
generating a user greeting with the obtained personalized information.

16. The method of claim 15, wherein the first type of personalized information is the user's schedule.

17. The method of claim 15, wherein the first type of personalized information is the user's task list.

18. The method of claim 15, wherein the first type of personalized information is the user's contacts.

19. The method of claim 15, further comprising obtaining a second type of personalized information.

20. The method of claim 19, wherein the second type of personalized information is from a database storing information of users of the corporate computer system.
